(19) United States
(12) Patent Application Publication
(10) Pub. No.: US 2017/0314383 A1
(43) Pub. Date: Nov. 2, 2017

(54) SITU METHOD OF ANALYZING MIXED-PHASE FLOW COMPOSITIONS

(71) Applicant: New Mexico Tech Research Foundation, Socorro, NM (US)

(72) Inventors: Titus ISPIRESCU, Albuquerque, NM (US); Robert BALCH, Socorro, NM (US); Nikolai KALUGIN, Albuquerque, NM (US)

(21) Appl. No.: 15/498,791

(22) Filed: Apr. 27, 2017

Related U.S. Application Data
(60) Provisional application No. 62/328,785, filed on Apr. 28, 2016.

(51) Int. Cl. E21B 47/01; G01N 21/65; G01N 21/3581; E21B 49/08; G01N 21/35

(52) U.S. Cl. CPC E21B 47/011; G01N 21/3581; E21B 49/081; G01N 21/65; E21B 2049/085; G01N 2021/3595

(57) ABSTRACT

The disclosure provides an instrument for determining the contents of a mixed-phase flow, such as that of a petroleum line. The instrument can use far-infrared, mid-infrared laser spectroscopy, Fourier transform spectroscopy, and Raman spectroscopy methods to determine the components of a mixture, and report the contents to a user.

### CROSS REFERENCE

This application claims the benefit of U.S. Provisional Application No. 62/328,785, filed Apr. 28, 2016, which is incorporated herein by reference in its entirety.

### BACKGROUND

Multi-phase flow meters assist with oil and gas flow surveillance, monitoring, and production allocation monitoring of individual oil and gas wells. Flows in production pipelines commonly contain mixtures and emulsions that can vary dramatically in composition over short periods of time. Determining the compositions and phase fractions of such mixtures is crucial for efficient resource valuation and determination, and for the prevention of potentially hazardous situations. Current multi-phase flow meters tend to be large, expensive, and employ ionizing radiation sources that require special licensing, training, and permits.

### INCORPORATION BY REFERENCE

Each patent, publication, and non-patent literature cited in the application is hereby incorporated by reference in its entirety as if each was incorporated by reference individually.

### SUMMARY OF THE INVENTION

In some embodiments, the invention provides a system for detecting the chemical composition of a mixed-phase flow, the system comprising: a) a main pipeline configured for a mixed-phase flow to flow through the main pipeline; b) a bypass loop connected to the main pipeline at a first junction and a second junction, wherein the bypass loop is configured to divert a portion of the mixed-phase flow from the main pipeline at the first junction and return the mixed-phase flow to the main pipeline at the second junction; and c) an optics assembly within the bypass loop configured to detect a component of the mixed-phase flow using far- or mid-infrared spectroscopy.

In some embodiments, the invention provides a method of detecting a chemical composition of a mixed-phase flow, the method comprising: a) flowing a mixed-phase flow within a fluid infrastructure through a channel; b) transmitting a far- or mid-infrared signal through the mixed-phase flow in the channel; c) detecting a transmittance of the far- or mid-infrared signal; and d) analyzing the transmittance to determine the chemical composition of the mixed-phase flow.

In some embodiments, the invention provides a method of detecting the chemical composition of a mixed-phase flow, the method comprising: a) flowing a mixed-phase flow within a fluid infrastructure through a temperature-controlled optical cell; b) transmitting electromagnetic radiation through the mixed-phase flow in the temperature-controlled optical cell; c) detecting a transmittance of the electromagnetic radiation through the mixed-phase flow; and d) analyzing the transmittance to determine a chemical composition of the mixed-phase flow.

### BRIEF DESCRIPTION OF THE FIGURES

FIG. 1 illustrates an in situ method of measuring the composition of a mixed-phase flow using far-infrared spectroscopy.

FIG. 2 illustrates an example configuration of a mixed-phase flow composition detection system that utilizes FTIR spectroscopy.

FIG. 3 illustrates an example configuration of a mixed-phase flow composition detection system that utilizes Raman spectroscopy.

FIG. 4 depicts a Fourier-transform infrared spectrum of a mixed-phase flow.

FIG. 5 illustrates the component scheme of an in situ mixed-phase flow composition detection system.

FIG. 6 illustrates the sample collection module of an in situ mixed-phase flow composition detection system.

FIG. 7 illustrates the sample preparation module of an in situ mixed-phase flow composition detection system.

FIG. 8 illustrates the optical detection module of an in situ mixed-phase flow composition detection system.

FIG. 9 illustrates a front view of the flow cell and tubing that sent a sample through the flow cell.

FIG. 10 illustrates a top view of a flow cell.

FIG. 11 PANEL A illustrates a front view of a flow cell. PANEL B illustrates a side view of a flow cell.

FIG. 12 illustrates a top view of a quantum cascade laser and photodetector arrangements around a flow cell.

FIG. 13 illustrates a side view of the quantum cascade laser and photodetector arrangements around the flow cell.

FIG. 14 illustrates external modules used to control an in situ mixed-phase flow composition detection system.

FIG. 15 illustrates the composition analysis of oil-water mixtures with carrying compositions.

### DETAILED DESCRIPTION

As large-scale and mature oil fields diminish, petroleum companies must find ways to make the operation of smaller fields more cost effective by reducing capital and operating costs. Multi-phase flow meters (MFMs) allow for the surveillance or monitoring of individual wells, real-time well testing, and production allocation monitoring. MFMs are also necessary for real-time product optimization, flow assurance, and improving the accuracy of legally-required reports of production measurements. Consequently, MFMs are critical for advancing oil and gas production techniques, making newer and smaller oil and gas production facilities more cost effective by reducing development and operational costs, allowing the establishment of production facilities in challenging physical environments, and improving energy efficiency.

Crude oil flowing through production pipelines is commonly composed of mixtures, emulsions, and slugs of brine, water, oil, and gases. Alternating series of water (i.e., brine) and gas (i.e., carbon dioxide) are often injected into reservoirs to increase the recovery of oil and gas. This practice results in changes in the water content and salinity of extracted products. In addition to native components, such as water, extracted products can also contain sand and chemical additives, such as scale inhibitors, corrosion inhibitors, and emulsion breakers that are added during the production process.

The extracted product of a well can vary dramatically in composition over short periods of time. Thus, immediate detection methods are necessary for producers to react to sudden changes in flow compositions. Additionally, quasi-real-time knowledge of the actual chemical composition of oil and gas flows is crucial for efficient resource evaluation and determination, the prevention of potentially hazardous situations, and modification of operational and production processes.

Difficulties in the real-time, in situ, continuous analyses of chemical compositions of oil and gas flows remain a critical problem for the petroleum and petro-chemical industries. When compositions of oil and gas are processed at plants (e.g., refiners and chemical plants), the exact ratios of oil and gas could be more efficiently processed with quasi-real-time knowledge of the compositions. Periodic analyses to determine chemical compositions do not provide the necessary continuity of measurements and are performed on samples after a flow has passed.

The majority of flow meters are divided into two groups. One type of flow meter relies on phase separation before measurements (Type 1); the second type utilizes a combination of techniques and technologies to measure the phase fractions and flow rates of mixed-phase flows directly (Type 2). Type 1 flow meters can be ineffective at separating foams, emulsions, and microbubbles. Type 2 flow meters can be more effective at analyzing mixed-phase samples and offer smaller footprints and lower weights than do Type 1 flow meters. However, obtaining accurate measurements with Type 2 flow meters often involves the use of ionizing radiation sources.

Most Type 2 MFMs that do not require full phase separation prior to analyses use gamma ray attenuation methods (i.e., densitometry) and involve the use of radioisotope sources to obtain phase fraction measurements. Due to the radioactive nature of gamma rays, such systems require supplementary licensing and instrument shielding for environmental protection. Phase fraction measurements can be made in situ at the operating temperature and pressure of a fluid infrastructure without the need to extract or alter a representative sample. This aspect minimizes the possibility of sample contamination and the risk of analyzing material that is not representative of the mixed-phase flow in a process line.

### Device.

The invention described herein can identify the components in a mixed-phase mixture, and their proportions in the mixture. The invention described herein can also determine the composition of a mixed-phase mixture in quasi-real-time mode. The invention described herein can provide volumetric or mass percentage contents of a mixed-phase sample based on the measured total flow rate. Individual flow rates can be derived, and measurements can be integrated over time to provide cumulative measurements.

The invention described herein can determine the chemical composition of a mixed-phase flow using long-wavelength laser far-infrared (FIR), mid-infrared (MIR), near-infrared (NIR), or visible radiation. In some embodiments, the invention can use Raman and Fourier transform infrared (FTIR) spectroscopy. In some embodiments, the invention can use quantum cascade lasers (QCLs) to generate mid- to far-infrared radiation. The invention can be used to build a lower cost, lower weight, and smaller footprint Type 2 MFM.

FIR/MIR or Raman systems can make measurements at the operating temperature and pressure of a fluid infrastructure without the need to extract or alter a representative sample. Interference of the components within a mixture, including water, methane, carbon dioxide, hydrogen sulfide, nitrogen, butane, and propane is minimized, and accurate measurements of the chemical components of a mixed-phase flow can be obtained.

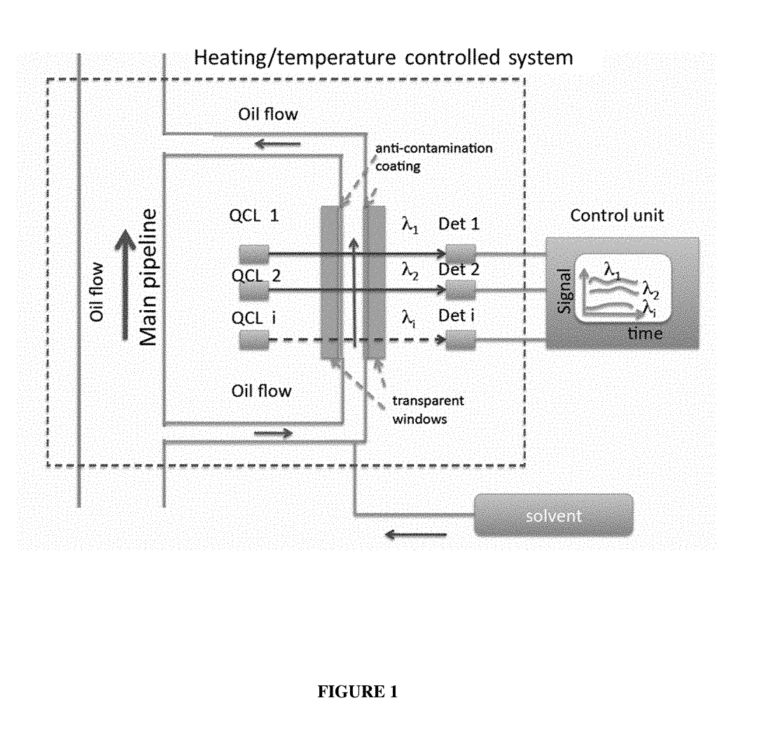

FIG. 1 illustrates a device comprising an FIR/MIR laser multi-wavelength spectrometer configured to determine the chemical composition of a mixed-phase flow. A multi-phase meter instrument can be installed, for example, at the wellhead or on a main pipeline that is used to transport crude oil to a refinery.

In some embodiments, a multi-phase meter instrument can be connected, for example, to an existing electrical grid. In some embodiments, a multi-phase meter instrument can be installed in a remote location and powered using an off-grid electric system. In some embodiments, a multi-phase meter instrument can be powered using solar of wind power technologies. In some embodiments, the multi-phase meter instrument can be connected to an off-grid power source and also be connected to an electrical grid.

### 1. Sample Collection.

A bypass loop can be connected to a main flow pipeline to divert a small amount of the mixed-phase flow away from the main pipeline for sampling. This architecture allows for the real-time and in situ monitoring of mixed-phase samples. In some embodiments, the flow of the bypass loop can be controlled using electrically actuated valves. In some embodiments, a sample is collected from a main flow source and injected into a device described herein.

In some embodiments, one line diverts a small amount of the mixed-phase flow away from the main pipeline for sampling, and the small amount of mixed-phase flow is returned back to the main pipeline after analysis. In some embodiments, the analyzed mixed-phase flow is returned to an exhaust/storage compartment that is attached to the main pipeline. In some embodiments, the flow of the analyzed mixed-phase flow to the main pipeline or the exhaust/storage compartment is controlled using electrically actuated valves.

### 2. Sample Preparation.

The bypass loop can be connected to a sample preparation module that treats the diverted mixed-phase sample prior to optical analysis. Sample preparation and treatment can be performed to provide proper homogeneity, stability, and viscosity of the sample. If the mixed-phase flow is too viscous to flow through the optics assembly, such as when a sample has high crude oil content, an amount of solvent can be added to the mix. If the surface tension between a pair of components of the mix is too high, for example, in a mixture of water and oil, an amount of a surfactant system can be added to the mix. The solvent and surfactant system additions can also help stabilize the sample such that separation of the components does not occur before measurement while allowing for the mixed-phase flow to run through the optics assembly.

An enclosure, for example, a consumables module, can house containers or tanks that hold organic solvent(s), an inert gas, a surfactant system, and/or a calibration mix. The consumable modules can be attached to the instrument and connected to the sample flow path (bypass loop) in different locations. The inert gas tank, for example, a nitrogen tank, can be connected to the solvent, surfactant system, and calibration mix tanks to pressurize the system and allow for flow without the need of an external pump. The inert gas tank can also be connected to a detection module through a separate line and valve, and provide positive pressure inside the detection module enclosure.

In some embodiments, the mixed-phase sample can be treated with solvent(s) or surfactant(s). In some embodiments, the mixed-phase sample can be treated with solvent(s) and surfactant(s). The solvent(s) and/or surfactant(s) can be added directly from pressurized tanks to the flow of the mixed-phase sample using individual flow lines and electrically actuated valves. In some embodiments, the mixed-phase sample can be treated with more than one solvent(s) or surfactant(s).

Non-limiting examples of suitable organic solvents include carboxylic acids, amides, alcohols, amines, ketones, aldehydes, esters, alkyl halides, ethers, aromatics, and alkanes. In some embodiments, suitable organic solvents can be acetic acid, acetic anhydride, acetone, acetonitrile, ammonia solution, benzene, benzonitrile, 1-butanol, 2-butanol, butyl acetate, tert-butyl alcohol, tert-butyl methyl ether, carbon disulfide, carbon tetrachloride, chlorobenzene, 1-chlorobutane, chloroform, cyclohexane, deuterium oxide, 1,2-dichlorobenzene, 1,2-dichloroethane, diethylamine, diethyl ether, diethyl ketone, diethylene glycol dimethyl ether, dimethyl sulfoxide, N,N-dimethylacetamide, dimethylether, N,N-dimethylformamide, 1,4-diooxane, ethanol, 2-ethoxyethyl ether, ethyl acetate, ethylene glycol dimethyl ether, ethylene glycol, formic acid, glycerin, heptane, hexamethylphosphor amide, hexamethylphosphorous triamide, hexanes, isoamyl alcohol, isobutyl alcohol, isopropanol, methanol, 2-methoxyethanol, 2-methoxyethyl acetate, methyl ethyl ketone, methyl isobutyl ketone, 1-methyl-2-pyrrolidinone, methylene chloride, nitromethane, 1-octanol, pentane, petroleum ether, propanoic acid, 1-propanol, propylene carbonate, pyridine, tetrachloroethylene, tetrahydrofuran, toluene, 1,1,2-trichlorotrifluoroethane, triethyl amine, 2,2,2-trifluoroethanol, water, m-xylene, o-xylene, or p-xylene. In some embodiments, suitable organic solvents can be 2-ethyoxyethanol, ethylene glycol monoethyl ether, 2-nitropropane, anisole, butanol, n-butyl alcohol, cresols (e.g., o-cresol, m-cresol, p-cresol, and mixtures thereof), cyclohexanone, dibutyl phthalate, ether, ethyl benzene, ethyl ether, glycerol, nitrobenzene, N-propanal, quinolone, trichlorofluoromethane, or trifluoroacetic acid. In some embodiments, suitable organic solvents can be mixtures of any of the solvents listed above.

An inert gas, solvent, or a surfactant can be added to the mixed-phase sample to flush the flow system and to reduce surface tension within the flow cell. In some embodiments, the inert gas is nitrogen, argon, or carbon dioxide. In some embodiments, the inert gas is nitrogen.

In some embodiments, the surfactant can be an anionic surfactant, cationic head-containing surfactant, zwitterionic surfactant, or non-ionic surfactant. In some embodiments, the anionic surfactant can be a sulfate, sulfonate, or phosphate ester. In some embodiments, the anionic surfactant is ammonium lauryl sulfate, sodium lauryl sulfate, sodium laureth sulfate, sodium myreth sulfate, dioctyl sodium sulfosuccinate, perfluorooctanesulfonate, perfluorobutanesulfonate, alkyl-aryl ether phosphates, or alkyl ether phosphates.

In some embodiments, the cationic head-containing surfactant can be octenidine dihydrochloride, or quaternary ammonium salts, including cetrimonium bromide (CTAB), cetylpyridinium chloride (CPC), benzalkonium chloride (BAC), benzethonium chloride (BZT), dimethyldioctadecylammonium chloride, or dioctadecyldimethylammonium bromide (DODAB). In some embodiments, zwitterionic surfactants can be 3-[(3-cholamidopropyl)dimethylamino]-1-propanesulfonate, cocamidopropyl hydroxysultaine, cocamidopropyl betaine, phospholipids phosphatidylserine, phosphatidylethanolamine, phosphatidylcholine, or sphingomyelins.

In some embodiments, nonionic surfactants can include polyethylene glycol alkyl ethers, polypropylene glycol alkyl ethers, glucoside alkyl ethers, polyethylene glycol octylphenyl ethers, polyethylene glycol alkylphenyl ethers, glycerol alkyl esters, polyoxyethylene glycol sorbitan alkyl esters, sorbitan alkyl esters, cocamide MEA, cocamide DEA, dodecyldimethylamine oxide, block copolymers of polyethylene glycol and polypropylene glycols, or polyethyoxylated tallow amine (POEA).

A calibration mixture can replace the mixed-phase sample for quantitative calibration. In some embodiments, the calibration mixture can be a mixture of known amounts of oil, water, and/or carbon dioxide. In some embodiments, the calibration mixture can include one or more components found in crude oil. In some embodiments, the calibration mixture allows for the evaluation of concentrations of the corresponding components in the mixed-phase sample. In some embodiments, the calibration mixture contains known amounts of the components that the device is quantifying. In some embodiments, the calibration mixture contains water, paraffins, naphthenes, aromatics, and asphaltics.

The mixed-phase flow can be homogenized prior to optical analysis and detection. In some embodiments, the mixed-phase flow is homogenized using an ultrasonic mixer. In some embodiments, the mixed-phase flow is homogenized more than once using an ultrasonic mixer. In some embodiments, the ultrasonic mixer comprises an ultrasonic generator, an ultrasonic converter, an ultrasonic probe, an ultrasonic mixing chamber, and a water-cooling jacket that allows for temperature control.

The ultrasonic mixer used to homogenize a sample can be temperature controlled. In some embodiments, a water-cooling jacket is used to control the temperature of the ultrasonic mixer. In some embodiments, vapor-compression refrigeration is used to control the temperature of the ultrasonic mixer. In some embodiments, a thermoelectric cooler (TEC) is used to control the temperature of the ultrasonic mixer. In some embodiments, the ultrasonic mixer is cooled to about −10° C., 0° C., 10° C., about 15° C., about 20° C., about 25° C., about 30° C., about 35° C., or about 40° C. In some embodiments, the ultrasonic mixer is cooled to about −10° C. In some embodiments, the ultrasonic mixer is cooled to about 0° C. In some embodiments, the ultrasonic mixer is cooled to about 10° C.

A pump can be installed at the outlet of the ultrasonic mixer. In some embodiments, the homogenized sample is diverted back to the ultrasonic mixer through an optional cycling loop for further ultrasonic mixing and homogenization. In some embodiments, the homogenized sample is flowed into a flow cell for optical detection and analysis. In some embodiments, the flow of the homogenized sample is controlled using electrically actuated valves.

### 3. Optical Detection.

A homogenized sample can be flowed into an optical detection device for composition analysis. In some embodiments, the optical detection module comprises a flow cell, a flow cell bypass loop, a line returning the analyzed sample back to the source or an exhaust/storage compartment, one or more QCLs, one or more shutters, one or more cold plates, one or more detectors, a cooling system, and a casing to allow a sample to be analyzed in an inert gas and water-free environment. In some embodiments, the optical detection module further comprises a pressure release valve on the enclosure (casing) of the optical detection system, and one or more mounts for the detector.

In some embodiments, the homogenized sample leaving the flow cell or flow cell bypass line is diverted back to the main pipeline. In some embodiments, flow of the homogenized sample back to the main pipeline is controlled using an electrically actuated valve. In some embodiments, the homogenized sample leaving the flow cell or flow cell bypass line is diverted to an exhaust/storage compartment. In some embodiments, flow of the homogenized sample into an exhaust/storage compartment is controlled using an electrically actuated valve.

The optical detection system can be equipped with an optics assembly, such as an optically transparent window that allows for FIR/MIR or Raman visible radiation to pass through the diverted mixed-phase flow. In some embodiments, the optically transparent window is made of ZnSe, amorphous material transmitting IR (AMTIR; As/Se/Ge), germanium, silicon, polyethylene, Quartz, or thallium bromoiodide (KRS-5). In some embodiments, the optically transparent window is made of ZnSe. In some embodiments, the optically transparent window is made of polyethylene. In some embodiments, the optically transparent window is made of Quartz.

The transparent window can be treated with an anti-contamination coating to decrease interference from accumulated contaminants in the optical cell and an anti-reflective coating to increase the transmission of radiation. Non-limiting examples of anti-contaminant coatings include fluoropolymers, such as polytetrafluoroethylene (PTFE). Non-limiting examples of contaminants accumulated in an optical cell include sulfur-, vanadium-, iron-, and zinc-containing compounds. Non-limiting examples of anti-reflecting coatings include magnesium fluoride and fluoropolymers.

The optically transparent windows can be positioned with spacers to separate the optical windows to an appropriate distance. In some embodiments, the optical window separator is made of PTFE. In some embodiments, the optical window separator is made of ethylene chlorotrifluoroethylene (E-CTFE).

The optically transparent windows can be positioned to be from about 1 micron to about 1 mm apart. In some embodiments, the optically transparent windows are separated by about 1 micron, about 5 microns, about 10 microns, about 20 microns, about 30 microns, about 40 microns, about 50 microns, about 60 microns, about 70 microns, about 80 microns, about 90 microns, or about 100 microns. In some embodiments, the optically transparent windows are separated by about 0.1 mm, about 0.2 mm, about 0.3 mm, about 0.4 mm, about 0.5 mm, about 0.6 mm, about 0.7 mm, about 0.8 mm, about 0.9 mm, or about 1 mm. In some embodiments, the optically transparent windows are positioned about 25 microns apart.

The optical detection system described herein can determine the chemical composition of a sample using long-wavelength laser far-infrared (FIR) and mid-infrared (MIR), near-infrared (NIR), or visible radiation. In some embodiments, the optical detection system uses Raman spectroscopy. In some embodiments, the optical detection system uses Fourier transform infrared (FTIR) spectroscopy. In some embodiments, the optical detection system uses quantum cascade lasers (QCLs).

Characteristic wavelengths can pass through the transparent window and the sample, and the beams are received by the corresponding detectors. In some embodiments, the optical detection system uses at least one QCL. In some embodiments, the optical detection system uses multiple QCLs that each emit different characteristic wavelengths (λᵢ). In some embodiments, the optical detection system uses two QCLs. In some embodiments, the optical detection system uses three QCLs.

In some embodiments, the characteristic wavelength is in the range of about 150 nm to about 2 μm. In some embodiments, the characteristic wavelength is in the range of about 2.5 μm to about 30 μm. In some embodiments, the characteristic wavelength is in the range of about 150 nm to about 30 μm.

The optical detection device of the invention can be about 100 mm, about 150 mm, about 200 mm, about 250 mm, or about 300 mm wide. The optical detection device of the invention can be about 200 mm, about 250 mm, about 300 mm, about 350 mm, about 400 mm, or about 450 mm wide. In some embodiments, the optical detection device of the invention is about 200 mm wide and about 355 mm long.

Upon receiving FIR/MIR/NIR/visible radiation transmittance or Raman shifts of the characteristic wavelengths, the detector(s) can transmit signals to a computer control unit. The computer system can display spectra, and the transmittance of radiation or Raman shifts can be used to identify the chemical composition of a mixed-phase flow based on the unique fingerprints of the chemical components in a sample.

### 4. Controls Systems.

The in situ mixed-phase flow composition detection system can comprise additional control systems, including a cooling and heating module, a power supply module, a controls panel, and a computer and communications module. In some embodiments, a cooling and heating module is used to contain the cooling and heating system used to cool the ultrasonic mixer's water-cooling jacket and the cold plates of the optical detection system.

In some embodiments, the power supplies module comprises power supplies for the cooling and heating system, the pump(s), the electrically actuated valves, and the shutters of the QCLs. In some embodiments, the controls panel comprises: power and energy management control, QCL drivers and HHL housing/TEC controls, IR detector and shutters control, sonicator generator and control, detection flow control, sample exhaust flow control, consumables flow control, sample preparation flow control, and sample collection flow control.

In some embodiments, the computer and communications module comprises a computer, data storage, a router/switch, and internet capability. In some embodiments, the internet capability is installed using 4G, copper cable, coaxial cable, fiber optics, satellite, and microwave technologies.

The main power module can allow the in situ mixed-phase flow composition detection system to be used in on- and off-grid settings. In some embodiments, the in situ mixed-phase flow composition detection system is powered using an accessible electric grid. In some embodiments, the in situ mixed-phase flow composition detection system is powered using an off-grid power source, such as solar and wind power technologies. In some embodiments, solar panels and wind turbines are used to generate electricity and to charge a battery bank. In some embodiments, a charged battery bank is used to power an on-line uninterruptible power supply (UPS). In some embodiments, the in situ mixed-phase flow composition detection system uses both on-grid power and off-grid power. In some embodiments, the in situ mixed-phase flow composition detection system uses solar panels, wind turbines, and power from an electric grid in combination to charge a battery bank and an on-line UPS system.

### Applications of the Device of the Invention.

A device described herein can determine the composition of a mixed-phase flow. Non-limiting examples of the compositions of mixed-phase flows include water, oil, hydrocarbons, carbon dioxide, nitrogen, hydrogen sulfide, brine composition, and salinity.

Non-limiting applications for which the device can be used include: the manufacturing and industrial processing of chemicals, pharmaceuticals, foods, textiles, paper, petroleum, gas, coal, plastics and rubber products; fueling stations, including gasoline, diesel, kerosene, and other oil-based fuel stations; transport and storage infrastructure; oil and gas extraction, transport, and refining; oil and gas extraction service providers; utilities; industrial processes, effluent monitoring from power plants; waste management, processing and treatment; and environmental protection.

### EXAMPLES

### Example 1: In Situ Mixed-Phase Flow Composition Detection System Using Far-Infrared and Mid-Infrared Spectroscopy

FIG. 1 is a diagram showing an example configuration of a mixed-phase flow composition detection system that utilizes FIR and MIR laser spectroscopy. A mixed-phase flow is transported through a main pipeline, such as crude oil that is transported from a well to a refinery. A bypass loop connects to the main pipeline in two positions, and diverts a small amount of the mixed-phase flow away from the main pipeline. The small amount of the mixed-phase flow moves through the bypass loop and is used as a sample, allowing for real-time and in situ monitoring of the chemical composition of the mixed-phase flow.

The bypass loop is equipped with an optics assembly, such as a transparent window, that allows for FIR/MIR laser radiation to pass through the diverted sample. The transparent window is treated with an anti-contamination coating to decrease interference from accumulated contaminants in the optical cell. The light source for FIR/MIR radiation can be quantum cascade lasers (QCLs) that emit radiation at different characteristic wavelengths (λᵢ). FIR/MIR radiation is passed through the transparent window and the diverted mixed-phased flow, and the beams are received by detectors that measure intensities at characteristic FIR/MIR wavelengths.

If the mixed-phase flow is viscous, such as crude oil, a container with an organic solvent can be attached to the bypass loop to treat the flow to facilitate entry of the mixed-phase flow into the optics assembly. The system is contained in a temperature-controlled assembly. The temperature-control system consists of insulation and/or a heating/cooling element.

Upon measuring intensities at characteristic wavelengths, the detector(s) transmit signals to a computer control unit. The computer system displays the transmittance of IR radiation that is used to quantify the chemical composition of a mixed-phase flow based on the unique fingerprints of the chemical components in the mixed-phase sample.

### Example 2: In Situ Mixed-Phase Flow Composition Detection System Using Fourier-Transform Infrared Spectroscopy

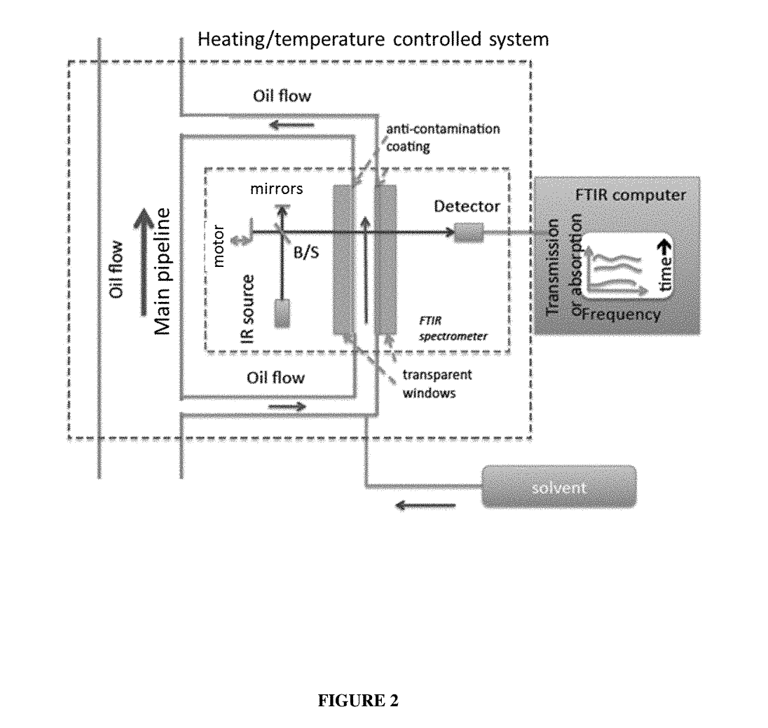

FIG. 2 illustrates an example configuration of a mixed-phase flow composition detection system that utilizes FTIR spectroscopy. A mixed-phase flow is transported through a main pipeline, such as crude oil that is transported from a well to a refinery. A bypass loop connects to the main pipeline in two positions, and diverts a small amount of the mixed-phase flow away from the main pipeline. The small amount of the mixed-phase flow moves through the bypass loop and is used as a sample, allowing for quasi-real-time and in situ determination of the chemical composition of the sample.

The bypass loop is equipped with an optics assembly, such as a transparent window, that allows for infrared radiation to pass through the diverted mixed-phase flow. The transparent window is treated with an anti-contamination coating to decrease interference from accumulated contaminants in the optical cell.

The IR source is a broadband light source that generates a beam containing the full spectrum of wavelengths to be measured. The beam is directed to a configuration of mirrors, one of which is moved by a motor. As this mirror moves, each wavelength of light in the beam is periodically blocked and transmitted due to wave interference. Different wavelengths of light are passed through the transparent windows and the sample and are subsequently received by a detector.

If the mixed-phase flow is viscous, such as crude oil, a container with an organic solvent can be attached to the bypass loop to treat the flow to facilitate entry of the mixed-phase flow into the optics assembly. The system is contained in a temperature-controlled assembly. The temperature-control system consists of insulation or a heating/cooling element.

Upon receiving the characteristic wavelengths, the detector transmits signals to a FTIR computer control unit. The computer system uses a Fourier transform to convert the raw data, which are used to identify the chemical composition of the mixed-phase flow based on the unique fingerprints of the chemical components within the mixed-phase sample.

### Example 3: In Situ Mixed-Phase Flow Composition Detection System Using Raman Spectroscopy

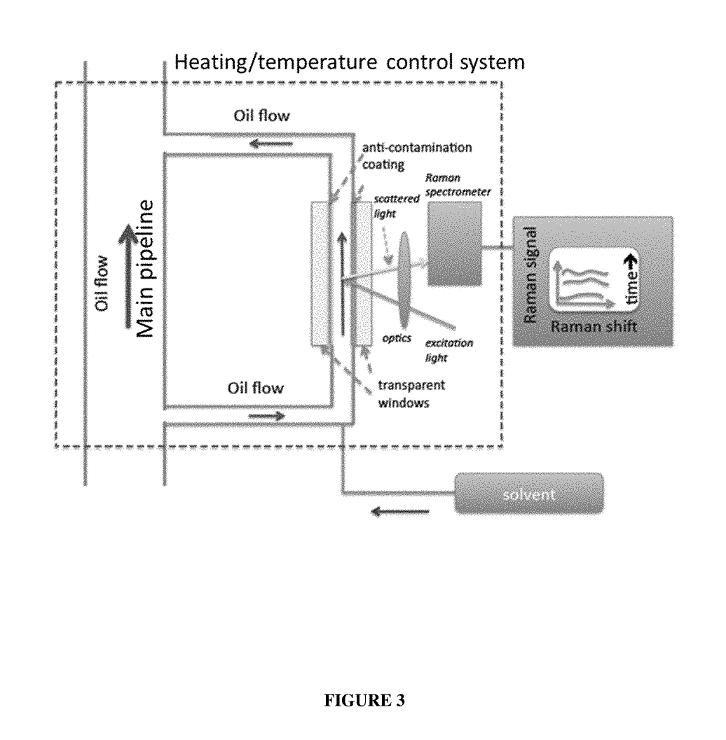

FIG. 3 illustrates an example configuration of a mixed-phase flow composition detection system that utilizes Raman spectroscopy. A mixed-phase flow is transported through a main pipeline, such as crude oil that is transported from a well to a refinery. A bypass loop connects to the main pipeline in two positions, and diverts a small amount of the mixed-phase flow away from the main pipeline. The small amount of the oil flow moves through the bypass loop and is used as a sample, allowing for real-time and in situ determination of the chemical composition of the mixed-phase flow.

The bypass loop is equipped with an optics assembly, such as a transparent window, that allows for NIR, visible (VIS), and/or ultraviolet (UV) radiation to pass through the diverted sample. The transparent window is treated with an anti-contamination coating to decrease interference from accumulated contaminants in the optical cell. An excitation light is passed through an optical lens and introduced to the mixed-phase flow. The scattered light is then collected through the lens and is sent to a Raman spectrometer.

If the mixed-phase flow is viscous, such as crude oil, a container with an organic solvent can be attached to the bypass loop to treat the flow to facilitate entry of the mixed-phased flow into the optics assembly. The system is contained in a temperature-controlled assembly. The temperature-control system consists of insulation or a heating/cooling element.

Upon receiving scattered radiation from the multi-phase flow, the Raman spectrometer transmits raw data to a computer control unit. The computer system processes the data and displays spectra, and the light intensity at Raman shifts (cm⁻¹) can be used to identify the chemical composition of a mixed-phase flow by using unique fingerprints of the chemical components within the mixed-phase sample.

### Example 4: Output from an In Situ Mixed-Phase Flow Composition Detection System

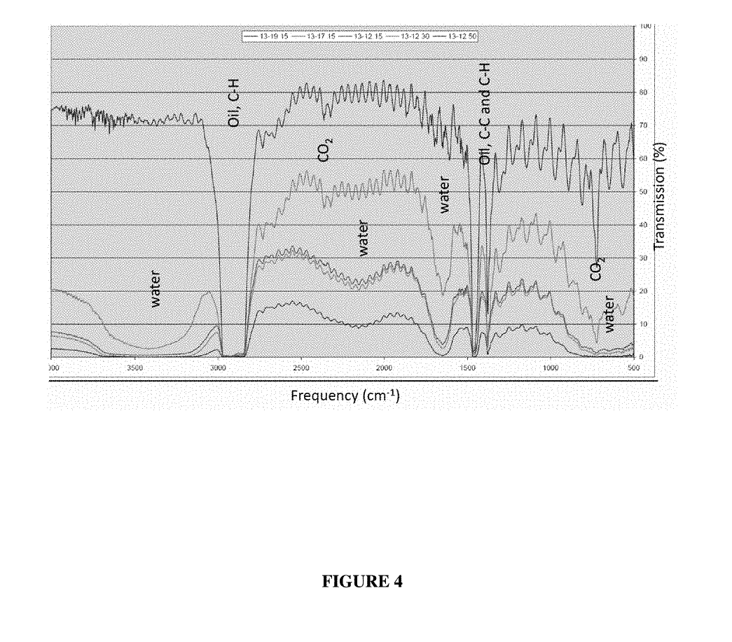

FIG. 4 displays a sample FTIR spectrum upon analyzing a diverted mixed-phase sample using an example system as described in FIG. 2. The spectrum details vibrational/rotational fingerprint lines and was able to identify the presence of chemical components within the sample, including water, oil, hydrocarbons, and carbon dioxide.

The top spectrum is of a sample mixture containing crude oil, CO₂, and is almost free of water. The middle spectrum is of a sample mix containing crude oil, CO₂, and contains a small amount of water. The three spectra on the bottom are mixtures containing crude oil, increasing amounts of water, and do not contain CO₂.

### Example 5: Working Prototype of In Situ Mixed-Phase Flow Composition Detection System Using Quantum Cascade Lasers

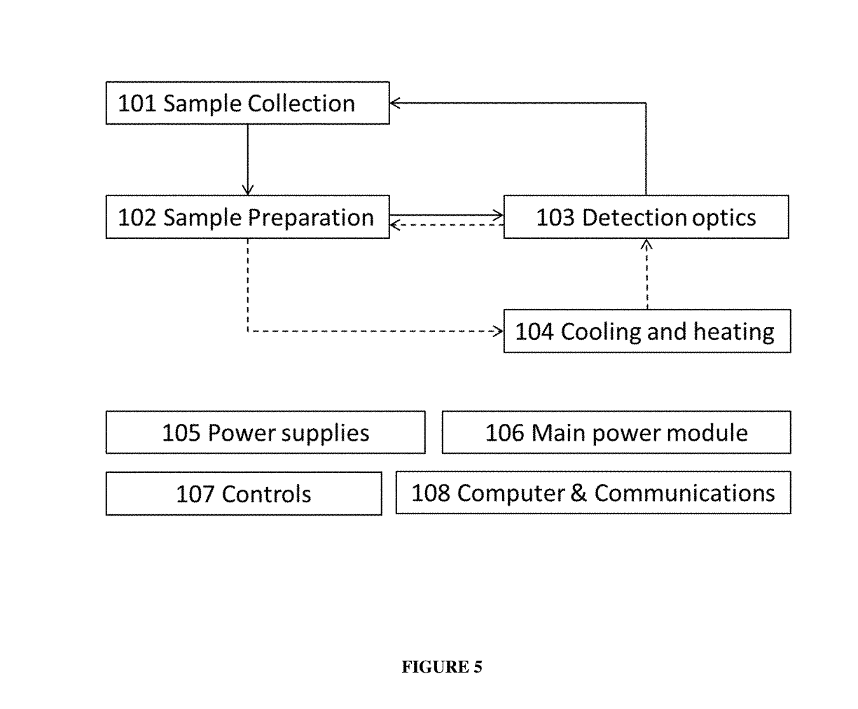

A working prototype of the in situ mixed-phase flow composition detection system consisted of 8 main components (FIG. 5). A sample was collected for analysis from the main flow pipeline (101). A small amount of the main flow was diverted to a sample preparation module (102), and the sample was prepared for analysis and flowed into the detection optics module (103). After analysis, the diverted mixed-phase sample was diverted back to the main flow pipeline of the sample collection module (101). A TEC heating and cooling system was used to cool the ultrasonic mixer body during sample preparation.

The in situ mixed-phase flow composition detection system also contained components that were used to control the detection system. Power supplies (105), a main power module (106), external controls (107), and computer and communications systems (108) were used to control the sample collection module (101), the sample preparation module (102), and the optical detection module (103).

FIG. 5 illustrates the relationship of the modules of the in situ mixed-phase flow composition detection system. 101 shows the sample collection module, and 102 shows the sample preparation module. 103 shows the optical detection module, and 104 shows the cooling and heating module. 105 shows the power supplies module, and 106 shows the main power module. 107 shows external controls, and 108 shows the computer and communications module. The solid lines depict flow of mixed-phase sample that was diverted from a main pipeline. The dotted lines depict flow of water used to cool the optical detection module (103) and the sample preparation module (102).

### A. 101 Sample Collection Module

A closed-loop main pipeline bypass system was installed on a section of the main flow pipeline. The line bypass system consisted of an outlet line that diverted a small stream of mixed-phased flow away from the main flow pipeline and an inlet line that could optionally return the diverted stream back into the main flow pipeline after analysis. Both the inlet and outlet lines were controlled using electrically actuated valves.

The sample collection module also included an exhaust/storage compartment. A sample could be returned back to the main pipeline or to the exhaust/storage compartment after analysis. Electrically actuated valves were installed on the line leading to the exhaust/storage compartment and on the line returning to the main flow pipeline such that a sample could be diverted to the exhaust/storage compartment.

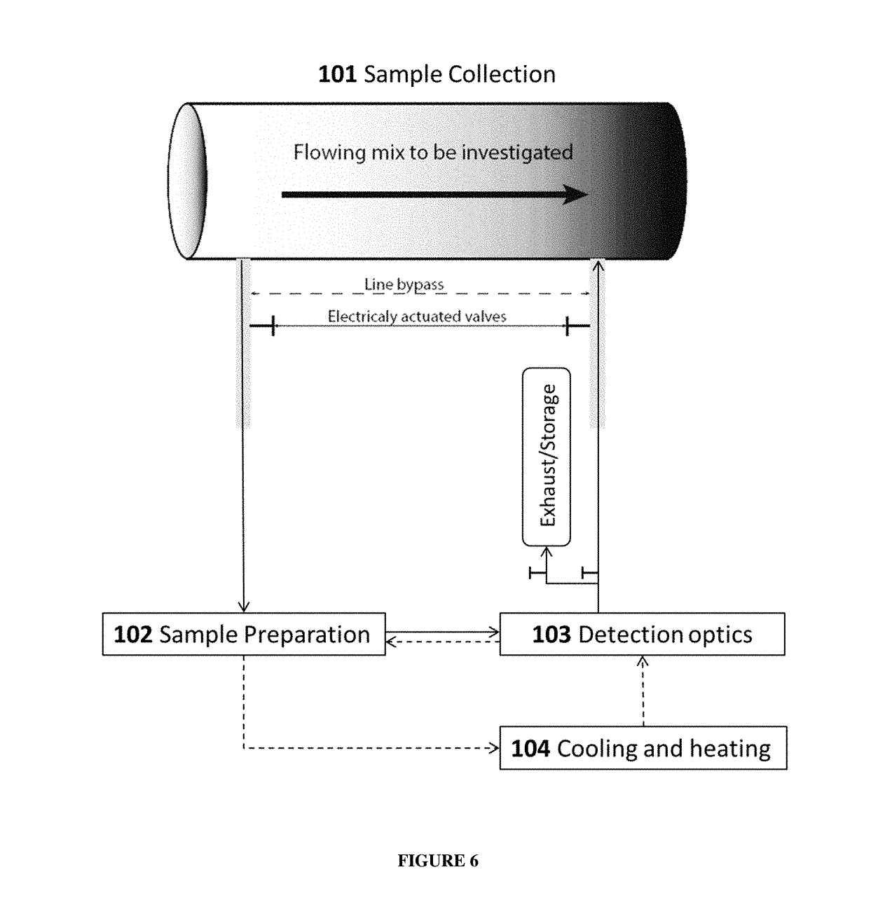

FIG. 6 illustrates the sample collection module of the in situ mixed-phase flow composition detection system. The sample collection module consisted of a line bypass system that diverted a small, continuous flow of a mixed-phase flow into the sample preparation (102) and optical detection (103) modules. An exhaust/storage compartment was installed on the return line to allow for the storage of a sample. The line bypass system and exhaust/storage compartments each had electrically actuated valves that controlled flow of the sample. The cooling and heating module (104) circulated cold water through the optical detection (103) and sample preparation modules (102) to cool the detection system. The solid arrows depict flow of the diverted mixed-phase sample, and the dotted lines depict flow of water that originated from the heating and cooling system (104).

### B. 102 Sample Preparation Module

The sample preparation module prepared a sample for analysis. Flow of the sample received from the sample collection module (101) was controlled using an electrically actuated valve. The sample was mixed with a solvent(s) and a surfactant(s) system, as necessary. The solvent(s), nitrogen, surfactant(s), and calibration mix were controlled from a consumables module, which added solvent(s), nitrogen, surfactant(s), and calibration mix directly to the bypass line using electrically actuated valves.

Samples with high viscosity or optical density were mixed with solvents. Inert gases, such as nitrogen, and surfactants were used to flush the flow system and reduce the surface tension of the sample. Calibration mixtures with known compositions were used to quantitatively calibrate the samples.

The resulting mixed-phase sample mixture was flowed into an ultrasonic mixer to homogenize the sample. Components of the ultrasonic mixer included a connection from an ultrasonic generator, an ultrasonic converter, an ultrasonic probe, a main ultrasonic mixer body, a water-cooling jacket, and a pump. The water-cooling jacket received cold water from the TEC chiller of the cooling and heating module (104), and returned warm water to the TEC chiller of the cooling and heating module (104). A pump was installed on the ultrasonic mixer; after a sample was homogenized, the sample was diverted to the optical detection module (103) for analysis. An optional cyclic loop allowed for a sample exiting the ultrasonic mixer to be returned to the ultrasonic mixer to be further homogenized. The line connecting the pump of the ultrasonic mixer and the optical detection module (103) was controlled using an electrically actuated valve.

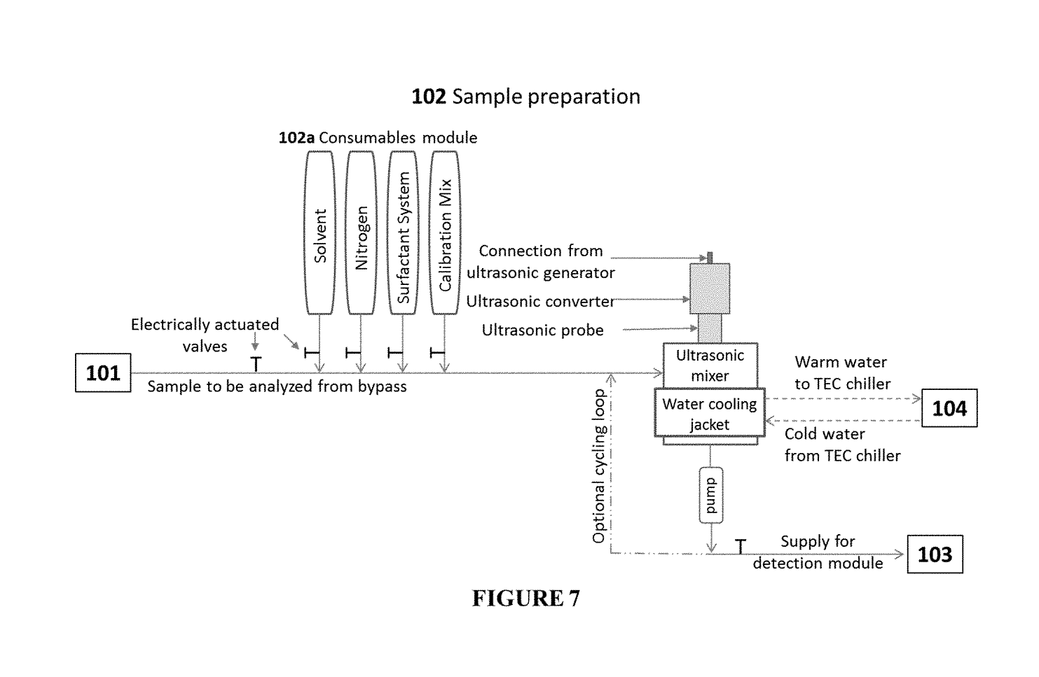

FIG. 7 illustrates the sample preparation module of the in situ mixed-phase flow composition detection system. A sample collected by the sample collection module (101) was treated with a solvent(s) and surfactant(s), and was subsequently flowed into an ultrasonic mixer. Flow of the sample, solvent(s), nitrogen, surfactant(s), and calibration mix were each controlled using electrically actuated valves. The ultrasonic mixer consisted of a connection from an ultrasonic generator, an ultrasonic converter, an ultrasonic probe, an ultrasonic mixer, a water-cooling jacket, and a pump. Cold water was sent to the water-cooling jacket by the cooling and heating module (104), and the water warmed by the ultrasonic mixer was returned to the cooling and heating module (104) for chilling by the TEC chiller.

### C. 103 Optical Detection Module

Upon homogenization of a sample in the sample preparation module (102), the sample was diverted to the optical detection module (103). The optical detection module (103) consisted of a flow cell, a detector, and three quantum cascade laser light sources. The homogenized sample from 102 was flowed into the flow cell, or was diverted around the flow cell through the flow cell bypass line. The line leading into the flow cell and the flow cell bypass line were controlled using electrically actuated valves. The sample was then returned to the source (i.e., main flow pipeline), and could optionally be flowed into the exhaust/storage compartment of the sample collection module (101).

The flow cell was equipped with optically transparent windows made of ZnSe. Three quantum cascade lasers were each mounted to a cold plate. The three quantum cascade lasers were mounted on kinematic mounts and aligned to provide vertical and horizontal alignment for propagation of laser beams through optical windows and the layer of the analyzed fluid mixture between the optical windows of the flow cell.

The thermo-detector absorbed IR radiation that passed through the fluid layer and generated a proportional electric response. The electric response of the detectors was proportional to the concentration of the components in the analyzed fluid, and was monitored in real time and in a continuous flow.

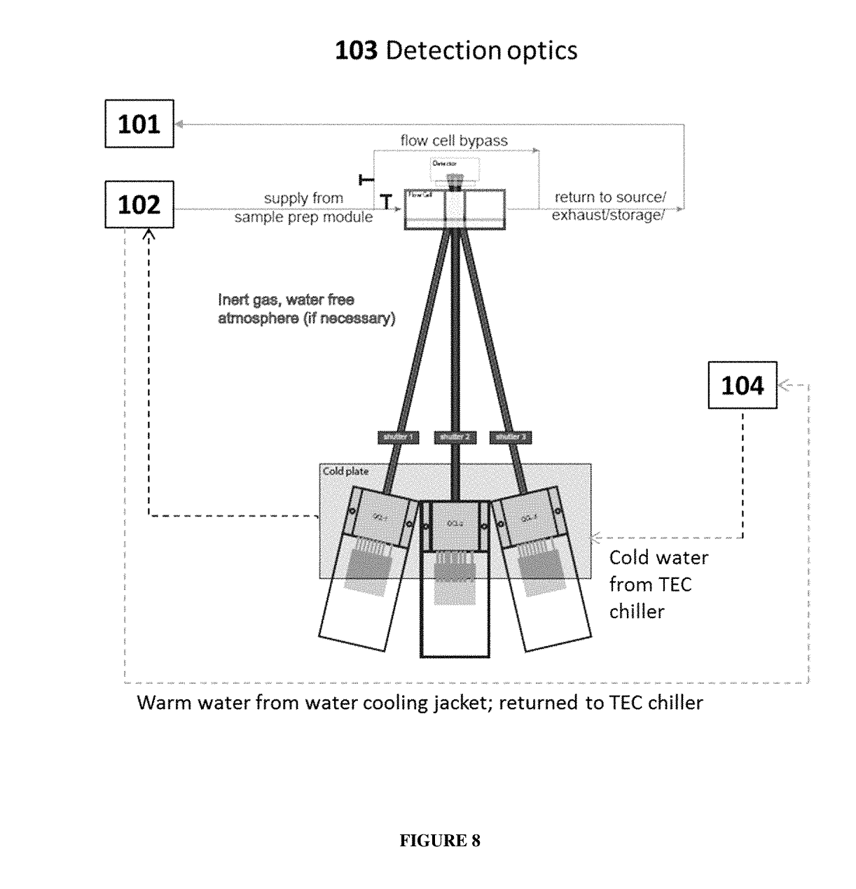

FIG. 8 illustrates the optical detection module of the in situ mixed-phase flow composition detection system. A homogenized sample was introduced to the detection optics module (103) through a line with an electrically actuated valve that led directly to the flow cell. A flow cell bypass line with an electrically actuated valve was introduced before the line connected to the flow cell, and was connected to the line exiting the flow cell. The line exiting the flow cell returned the sample flow back to the main pipeline, or could optionally flow the sample into the exhaust/storage component of the sample collection module (101). A detector was mounted in proximity to the flow cell. Three QCLs were placed on top of cold plates and mounted on kinematic mounts. The QCLs each emitted laser beams through three individual shutters (i.e., shutters 1, 2, and 3), which were passed through the flow cell sequentially and entered the detector aperture. The thick dark lines depict laser beams generated by each of the three QCLs. Cold water was sent from the TEC chiller of the cooling and heating module (104). Cold water cooled the cold plates, and subsequently cooled the water-cooling jacket of the ultrasonic mixer of the sample preparation module (102), and was returned back to the cooling and heating module (104). The thermal detection module (103) was filled with an inert gas, water free atmosphere when necessary.

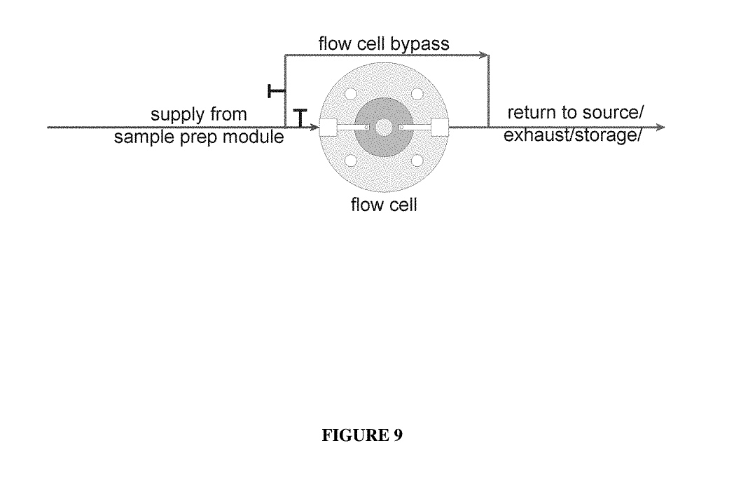

FIG. 9 illustrates a front view of the flow cell and tubing that sent a sample through the flow cell. A sample was supplied from the sample preparation module (102). The sample line had an electrically actuated valve, and was connected to the flow cell. A flow cell bypass line with an electrically actuated valve was introduced before the sample line connected to the flow cell, and connected to the line exiting the flow cell. The sample exiting the flow cell was returned to the main pipeline or the exhaust/storage compartment of the sample collection module (101).

The flow cell consisted of two parts, and accommodated standard optical windows. The flow cell also included spacers that separated the optical windows by 25 microns. Fluid tubes were connected to the flow cell with a Swagelok™ to parallel tread fittings, which allowed the delivery of the homogenized fluid mixture into the space between the optical windows via holes in one of the optical windows. The flow cell used two shoulder screws to align and tighten the parts together, which avoided unnecessary bending and cracks in the optical windows. For high-pressure conditions, four or six bolt patterns were used.

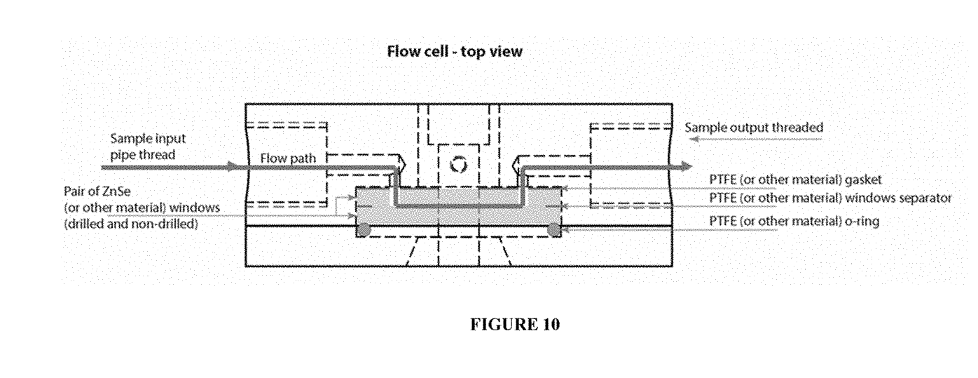

FIG. 10 illustrates a top view of the flow cell. A sample tube was connected to the flow cell with a Swagelok™ fitting, and was threaded into the flow cell body where the line entered (i.e., sample input) and exited (i.e., sample output) the flow cell. The flow cell body was composed of two parts: the main part accommodated mounting of the flow cell to a support via a threaded hole in the bottom of the flow cell. The input and output connections were introduced via two lateral threaded ports with copper-faced seals. The main part of the flow cell held the gasket, drilled window, separator, and the non-drilled window in a tight tolerance concentric, transversal pocket. The secondary flow cell body also had a matching pocket that held the windows stack via a PTFE O-ring. The two flow cell body parts were aligned and held in place by two shoulder screws mounted in matching counterbores with spring washers and nuts. The flow cell body was machined out of 316 stainless steel.

The gray area shows a pair of ZnSe windows that were 32 mm in diameter and 3 mm thick. One of the windows was drilled symmetrically in two locations, 19 mm apart, which matched the two ports in the body of the flow cell and allowed flow from and to the lateral access ports. A PTFE gasket with matching holds was used to seal the window against the flow cell body and to contain the sample flow. A 25 micron-thick PTFE space was installed between the two windows (one drilled window and one non-drilled window). The pair of ZnSe windows was held in place using a gasket, window separator, and O-ring, each of which was independently made of PTFE. The solid line with arrows depicts the flow path of the homogenized sample stream.

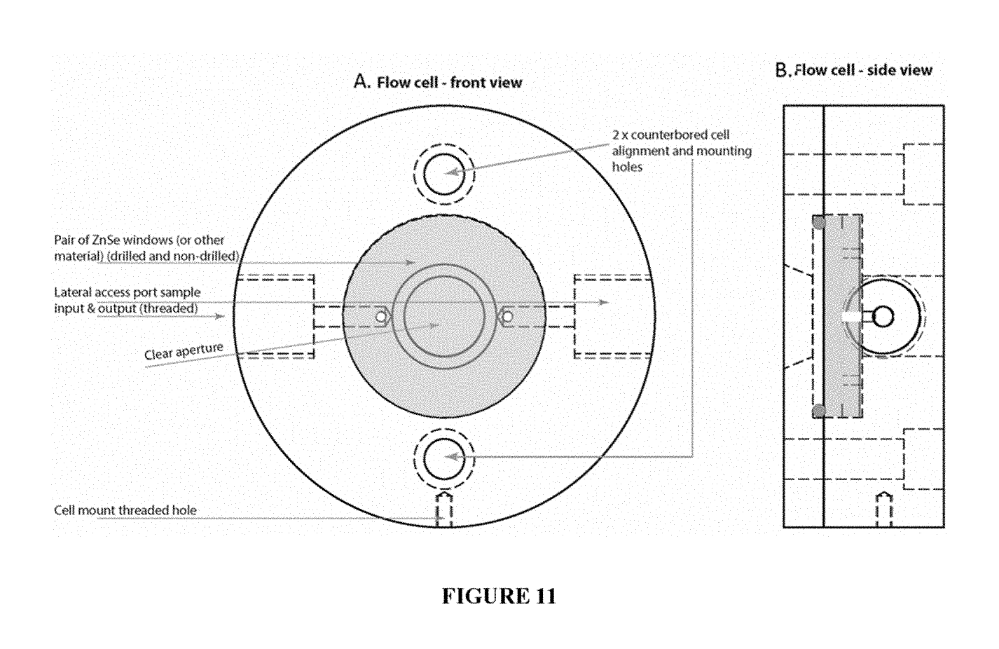

FIG. 11 PANEL A illustrates a front view of the flow cell. The flow cell was mounted onto a base using a cell mount threaded hole. The flow cell was mounted and aligned using two counterbore cell alignment and mounting holes located at the top and bottom of the flow cell. The input and output of the lateral access ports were threaded on the sides of the flow cell. The pair of ZnSe windows (one drilled window and one non-drilled window), depicted in gray, was secured in the center of the flow cell. The clear aperture at the center of the flow cell allowed laser beams to pass through the sample into the detector aperture for analysis.

FIG. 11 PANEL B illustrates a side view of the flow cell. The flow cell was mounted and aligned by counterbore holes and shoulder screws located at the top and bottom of the flow cell. The pair of ZnSe windows, depicted in gray, was secured in the center of the flow cell.

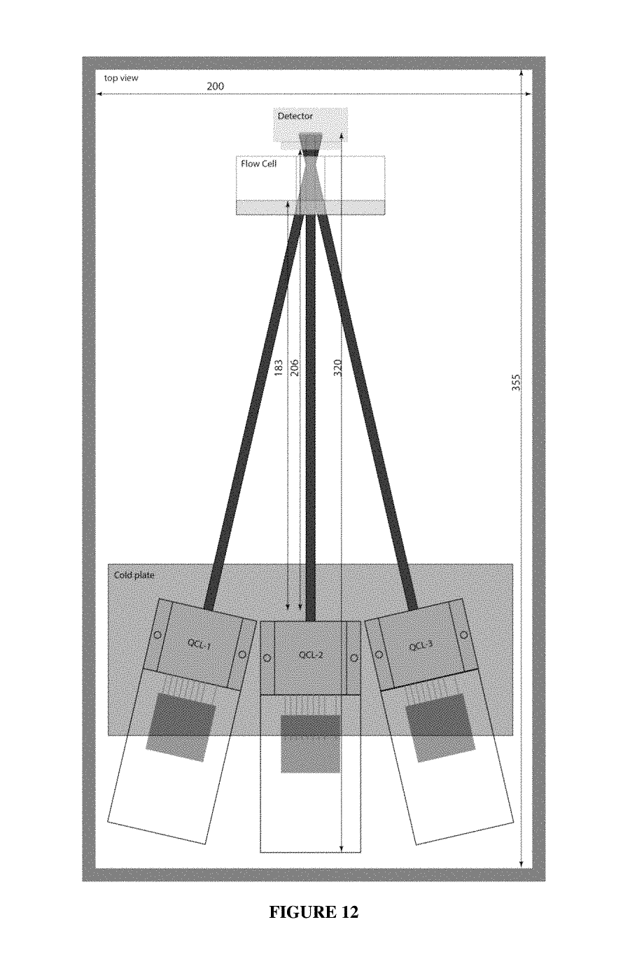

FIG. 12 illustrates a top view of the quantum cascade laser and thermal detector arrangements around the flow cell. The figure shows a variation of the detection system using three QCLs covering three different wavelengths, which were used to detect three individual components within a mixed-phase flow sample. The optical detection module was 200-250 mm in width and 355 mm in length. The distance between the central QCL (QCL-2) and the entrance of the flow cell was 183 mm. The distance between the central QCL (QCL-2) and the exit of the flow cell was 206 mm. The distance between the central QCL (QCL-2) and the detector was 320 mm. The thick dark lines denote the laser beams emitted by each of the QCLs.

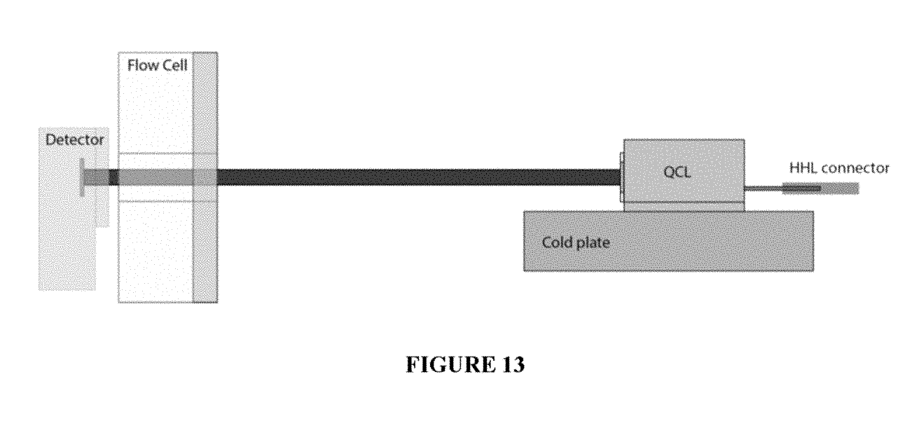

FIG. 13 illustrates a side view of the quantum cascade laser and thermal detector arrangements around the flow cell. Each QCL was integrated in an HHL housing by the manufacturer and was connected to a high heat load (HHL) connector, and mounted on a kinematics mount and a cold plate. Each laser beam, when its shutter was open, penetrated the flow cell and the sample passing through the flow cell, and was absorbed by the detector. The detector was positioned closely behind the flow cell. The thick dark line denotes the laser beams generated by the QCLs. The detector had an aperture of 10 mm. The flow cell had a clear aperture of 12.7 mm. The laser beam had a maximum diameter of 4 mm at the HHL exit face and a divergence of less than 6 mRad.

### D. 105 Power Supplies Module, 106 Main Power Module, 107 External Controls Module, and 108 Computer and Communications Module

The in situ mixed-phase flow composition detection system also comprised system components that powered and controlled the sample collection module, sample preparation module, optical detection module, and cooling and heating module. The power supplies module (105) consisted of power supply units for the TEC chiller, the pump(s), the electrically actuated valves, and the shutters for the QCLs.

The main power module (106) allowed for the in situ mixed-phase flow composition detection system to be used in remote areas that lacked access to an electrical grid. Solar panels and wind turbines were used to generate electricity, which charged a battery bank using a battery charge controller. The battery bank supplied an on-line uninterruptible power supply (UPS), which was connected to an electric grid.

The controls module (107) consisted of various control systems including controls for: power/energy management, QCL drivers and the integrated TEC, the IR detector and shutters, the TEC chiller, the sonicator generator, detection flow, sample exhaust flow, consumables flow, sample prep flow, and sample collection flow.

The computer and communications module (108) consisted of a computer, data storage, a router/switch, and access to the internet to communicate data.

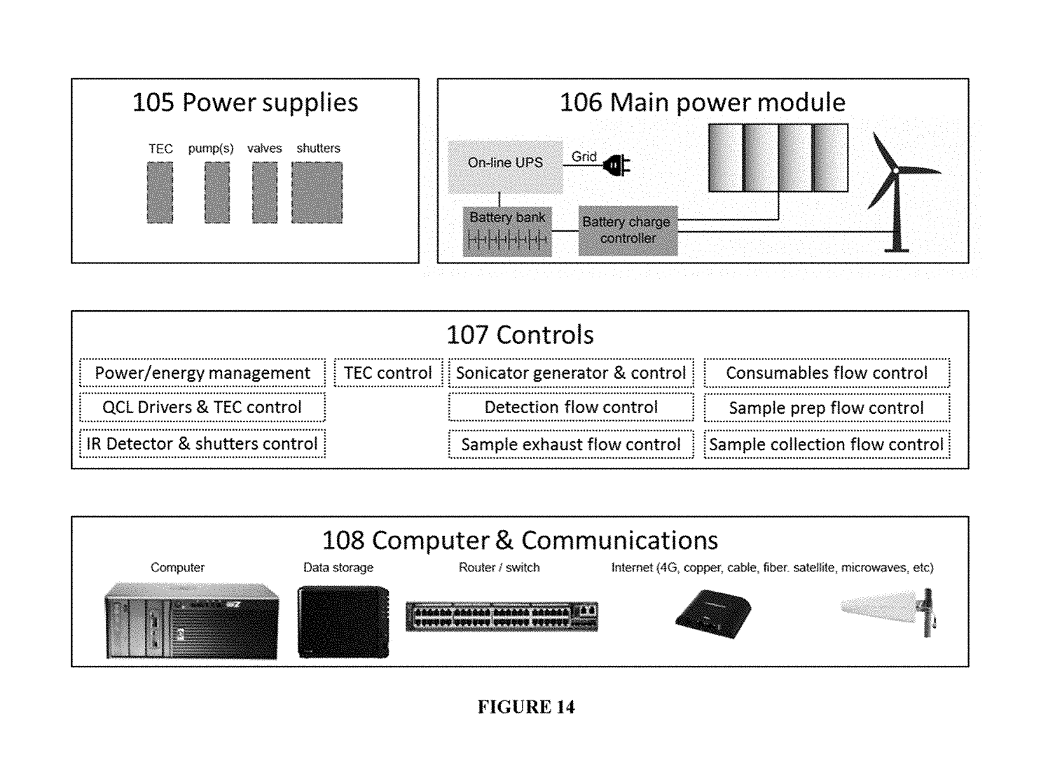

FIG. 14 illustrates external modules used to control the in situ mixed-phase flow composition detection system using QCL lasers.

### Example 6: Analysis of Mixed-Phase Solutions

The in situ mixed-phase flow composition detection system of EXAMPLE 5 was used to analyze oil-water mixtures of varying ratios. Oil-water mixtures that consisted of 50% oil, 70% oil, and 90% oil were analyzed. The oil-water mixtures were analyzed using ZnSe windows and a 25-micron layer of fluid between the optical windows of the flow cell. Water scissor bend absorption was observed at about 6.09 microns, and C—H bend absorption was observed at about 7.26 microns.

Absorption spectra were obtained for samples with 50%, 70%, and 90% oil contents in oil-water mixtures. The data show that an increase in water content increased absorption and lowered transmission of water scissor bend absorption at about 6.09 microns. The data also show that an increase in oil content decreased absorption and increased transmission of C—H bend absorption at about 7.26 microns.

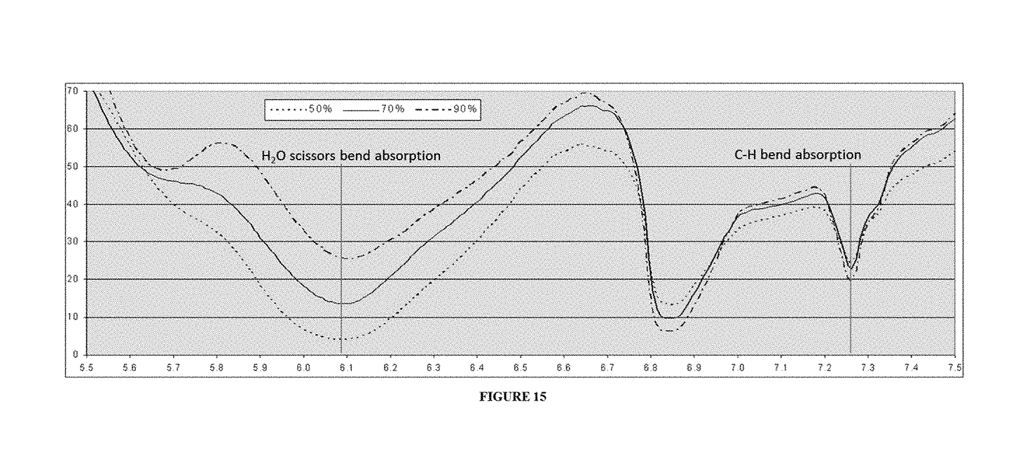

FIG. 15 illustrates the composition analysis of oil-water mixtures with carrying compositions. The dotted line depicts the absorption spectrum of a 50% oil-water mixture. The solid line depicts the absorption spectrum of a 70% oil-water mixture (30% water). The dashed line depicts the absorption spectrum of a 90% oil-water mixture (10% water).

### EMBODIMENTS

### Embodiment 1

A system for detecting the chemical composition of a mixed-phase flow, the system comprising: a) a main pipeline configured for a mixed-phase flow to flow through the main pipeline; b) a bypass loop connected to the main pipeline at a first junction and a second junction, wherein the bypass loop is configured to divert a portion of the mixed-phase flow from the main pipeline at the first junction and return the mixed-phase flow to the main pipeline at the second junction; and c) an optics assembly within the bypass loop configured to detect a component of the mixed-phase flow using far- or mid-infrared spectroscopy.

### Embodiment 2

The system of embodiment 1, wherein the optics assembly comprises a transparent optical cell incorporated into the bypass loop.

### Embodiment 3

The system of any one of embodiments 1-2, wherein the optics assembly further comprises a light source configured to emit far- or mid-infrared radiation through the transparent optical cell and the mixed-phase flow.

### Embodiment 4

The system of any one of embodiments 1-3, wherein the optics assembly further comprises a detector that detects far- or mid-infrared radiation that has passed through the mixed-phase flow.

### Embodiment 5

The system of any one of embodiments 1-4, further comprising a computer system configured to receive data from the detector and process the data to identify a compound of the mixed-phase flow.

### Embodiment 6

The system of any one of embodiments 1-5, further comprising a solvent dispenser connected to the bypass loop after the first junction, configured to treat the mixed-phase flow prior to entering the optics assembly.

### Embodiment 7

A method of detecting a chemical composition of a mixed-phase flow, the method comprising: a) flowing a mixed-phase flow within a fluid infrastructure through a channel; b) transmitting a far- or mid-infrared signal through the mixed-phase flow in the channel; c) detecting a transmittance of the far- or mid-infrared signal or a Raman-specific signal; and d) analyzing the transmittance or Raman shift to determine the chemical composition of the mixed-phase flow.

### Embodiment 8

The method of embodiment 7, wherein the transmittance of the far- or mid-infrared signal or Raman shift is analyzed in real-time.

### Embodiment 9

The method of any one of embodiments 7-8, wherein the mixed-phase flow is sampled in situ.

### Embodiment 10

The method of any one of embodiments 7-9, wherein the far-infrared signal has a wavelength range from 4000 cm⁻¹ to 10 cm⁻¹.

### Embodiment 11

The method of any one of embodiments 7-10, wherein a portion of the channel is coated with an anti-contamination coating.

### Embodiment 12

The method of any one of embodiments 7-11, further comprising treating the mixed-phase flow with an organic solvent prior to being introduced to the channel.

### Embodiment 13

The method of any one of embodiments 7-12, wherein the mixed-phase flow comprises petroleum.

### Embodiment 14

The method of any one of embodiments 7-13, wherein the mixed-phase flow comprises petroleum, gas molecules, and water.

### Embodiment 15

The method of any one of embodiments 7-14, wherein the mixed-phase flow comprises gaseous CO₂, H₂S, N₂ and hydrocarbons.

### Embodiment 16

The method of any one of embodiments 7-15, wherein the mixed-phase flow comprises wastewater.

### Embodiment 17

The method of any one of embodiments 7-16, further comprising determining a brine composition and a salinity of the mixed-phase flow based on the transmittance or Raman shift of the mixed-phase flow.

### Embodiment 18

A method of detecting the chemical composition of a mixed-phase flow, the method comprising: a) flowing a mixed-phase flow within a fluid infrastructure through a temperature-controlled optical cell; b) transmitting electromagnetic radiation through the mixed-phase flow in the temperature-controlled optical cell; c) detecting a transmittance of the electromagnetic radiation through the mixed-phase flow; and d) analyzing the transmittance to determine a chemical composition of the mixed-phase flow.

### Embodiment 19

The method of embodiment 18, wherein the transmittance of the electromagnetic radiation is analyzed in real-time.

### Embodiment 20

The method of any one of embodiments 18-19, wherein the mixed-phase flow is sampled in situ.

### Embodiment 21

The method of any one of embodiments 18-20, wherein the electromagnetic radiation is far- or mid-infrared radiation.

### Embodiment 22

The method of any one of embodiments 18-21, wherein the far- or mid-infrared signal has a wavelength range from 4000 cm⁻¹ to 10 cm⁻¹.

### Embodiment 23

The method of any one of embodiments 18-22, wherein a portion of the temperature-controlled optical cell is coated with an anti-contaminant coating.

### Embodiment 24

The method of any one of embodiments 18-23, further comprising treating the mixed-phase flow with an organic solvent prior to being introduced to the temperature-controlled optical cell.

### Embodiment 25

The method of any one of embodiments 18-24, wherein the mixed-phase flow comprises petroleum.

### Embodiment 26

The method of any one of embodiments 18-25, wherein the mixed-phase flow comprises petroleum, gas molecules, and water.

### Embodiment 27

The method of any one of embodiments 18-26, wherein the mixed-phase flow comprises gaseous CO₂, H₂S, N₂ and hydrocarbons.

### Embodiment 28

The method of any one of embodiments 18-27, wherein the mixed-phase flow comprises wastewater.

### Embodiment 29

The method of any one of embodiments 18-28, further comprising determining a brine composition and a salinity of the mixed-phase flow based on the transmittance of the mixed-phase flow.

### Embodiment 30

The method of any one of embodiments 18-29, wherein the temperature-controlled optical cell comprises insulation.

### Embodiment 31

The method of any one of embodiments 18-30, wherein the temperature-controlled optical cell comprises an electric heating element.

### Embodiment 32

The method of any one of embodiments 18-30, wherein the temperature-controlled optical cell comprises an electric cooling element.

### Embodiment 101

A system for detecting the chemical composition of a mixed-phase flow, the system comprising: a) a main pipeline configured for a mixed-phase flow to flow through the main pipeline; b) a bypass loop connected to the main pipeline at a first junction and a second junction, wherein the bypass loop is configured to divert a portion of the mixed-phase flow from the main pipeline at the first junction and return the mixed-phase flow to the main pipeline at the second junction; and c) an optics assembly within the bypass loop configured to detect a component of the mixed-phase flow using near-infrared or visible spectroscopy.

### Embodiment 102

The system of embodiment 101, wherein the optics assembly comprises a transparent optical cell incorporated into the bypass loop.

### Embodiment 103

The system of any one of embodiments 101-102, wherein the optics assembly further comprises a light source configured to emit near-infrared or visible radiation through the transparent optical cell and the mixed-phase flow.

### Embodiment 104

The system of any one of embodiments 101-103, wherein the optics assembly further comprises a detector that detects near-infrared or visible radiation that has passed through the mixed-phase flow.

### Embodiment 105

The system of any one of embodiments 101-104, further comprising a computer system configured to receive data from the detector and process the data to identify a compound of the mixed-phase flow.

### Embodiment 106

The system of any one of embodiments 1-5, further comprising a solvent dispenser connected to the bypass loop after the first junction, configured to treat the mixed-phase flow prior to entering the optics assembly.

### Embodiment 107

A method of detecting a chemical composition of a mixed-phase flow, the method comprising: a) flowing a mixed-phase flow within a fluid infrastructure through a channel; b) transmitting a near-infrared or visible radiation signal through the mixed-phase flow in the channel; c) detecting a transmittance of the near-infrared or visible radiation signal; and d) analyzing the transmittance to determine the chemical composition of the mixed-phase flow.

### Embodiment 108

The method of embodiment 7, wherein the transmittance of the near-infrared or visible radiation signal is analyzed in real-time.

### Embodiment 109

The method of any one of embodiments 7-8, wherein the mixed-phase flow is sampled in situ.

### Embodiment 110

The method of any one of embodiments 7-9, wherein the near-infrared or visible radiation signal has a wavelength range from 4000 cm⁻¹ to 10 cm⁻¹.

### Embodiment 111

The method of any one of embodiments 7-10, wherein a portion of the channel is coated with an anti-contamination coating.

### Embodiment 112

The method of any one of embodiments 7-11, further comprising treating the mixed-phase flow with an organic solvent prior to being introduced to the channel.

### Embodiment 113

The method of any one of embodiments 7-12, wherein the mixed-phase flow comprises petroleum.

### Embodiment 114

The method of any one of embodiments 7-13, wherein the mixed-phase flow comprises petroleum, gas molecules, and water.

### Embodiment 115

The method of any one of embodiments 7-14, wherein the mixed-phase flow comprises gaseous CO₂, H₂S, N₂ and hydrocarbons.

### Embodiment 116

The method of any one of embodiments 7-15, wherein the mixed-phase flow comprises wastewater.

### Embodiment 117

The method of any one of embodiments 7-16, further comprising determining a brine composition and a salinity of the mixed-phase flow based on the transmittance of the mixed-phase flow.

### Embodiment 118

A method of detecting the chemical composition of a mixed-phase flow, the method comprising: a) flowing a mixed-phase flow within a fluid infrastructure through a temperature-controlled optical cell; b) transmitting electromagnetic radiation through the mixed-phase flow in the temperature-controlled optical cell; c) detecting a transmittance of the electromagnetic radiation through the mixed-phase flow; and d) analyzing the transmittance to determine a chemical composition of the mixed-phase flow.

### Embodiment 119

The method of embodiment 18, wherein the transmittance of the electromagnetic radiation is analyzed in real-time.

### Embodiment 120

The method of any one of embodiments 18-19, wherein the mixed-phase flow is sampled in situ.

### Embodiment 121

The method of any one of embodiments 18-20, wherein the electromagnetic radiation is near-infrared or visible radiation.

### Embodiment 122

The method of any one of embodiments 18-21, wherein the near-infrared or visible radiation signal has a wavelength range from 4000 cm⁻¹ to 10 cm⁻¹.

### Embodiment 123

The method of any one of embodiments 18-22, wherein a portion of the temperature-controlled optical cell is coated with an anti-contaminant coating.

### Embodiment 124

The method of any one of embodiments 18-23, further comprising treating the mixed-phase flow with an organic solvent prior to being introduced to the temperature-controlled optical cell.

### Embodiment 125

The method of any one of embodiments 18-24, wherein the mixed-phase flow comprises petroleum.

### Embodiment 126

The method of any one of embodiments 18-25, wherein the mixed-phase flow comprises petroleum, gas molecules, and water.

### Embodiment 127

The method of any one of embodiments 18-26, wherein the mixed-phase flow comprises gaseous CO₂, H₂S, N₂ and hydrocarbons.

### Embodiment 128

The method of any one of embodiments 18-27, wherein the mixed-phase flow comprises wastewater.

### Embodiment 129

The method of any one of embodiments 18-28, further comprising determining a brine composition and a salinity of the mixed-phase flow based on the transmittance of the mixed-phase flow.

### Embodiment 130

The method of any one of embodiments 18-29, wherein the temperature-controlled optical cell comprises insulation.

### Embodiment 131

The method of any one of embodiments 18-30, wherein the temperature-controlled optical cell comprises an electric heating element.

### Embodiment 132

The method of any one of embodiments 18-30, wherein the temperature-controlled optical cell comprises an electric cooling element.

1. A system for detecting the chemical composition of a mixed-phase flow, the system comprising:
a) a main pipeline configured for a mixed-phase flow to flow through the main pipeline;
b) a bypass loop connected to the main pipeline at a first junction and a second junction, wherein the bypass loop is configured to divert a portion of the mixed-phase flow from the main pipeline at the first junction and return the mixed-phase flow to the main pipeline at the second junction; and
c) an optics assembly within the bypass loop configured to detect a component of the mixed-phase flow using far- or mid-infrared spectroscopy.

2. The system of claim 1, wherein the optics assembly comprises a transparent optical cell incorporated into the bypass loop.

3. The system of claim 2, wherein the optics assembly further comprises a light source configured to emit far- or mid-infrared radiation through the transparent optical cell and the mixed-phase flow.

4. The system of claim 3, wherein the optics assembly further comprises a detector that detects far- or mid-infrared radiation that has passed through the mixed-phase flow.

5. The system of claim 4, further comprising a computer system configured to receive data from the detector and process the data to identify a compound of the mixed-phase flow.

6. The system of claim 1, further comprising a solvent dispenser connected to the bypass loop after the first junction, configured to treat the mixed-phase flow prior to entering the optics assembly.

7. A method of detecting a chemical composition of a mixed-phase flow, the method comprising:
a) flowing a mixed-phase flow within a fluid infrastructure through a channel;
b) transmitting a far- or mid-infrared signal through the mixed-phase flow in the channel;
c) detecting a transmittance of the far- or mid-infrared signal; and
d) analyzing the transmittance to determine the chemical composition of the mixed-phase flow.

8. The method of claim 7, wherein the transmittance of the far- or mid-infrared signal is analyzed in real-time.

9. The method of claim 7, wherein the mixed-phase flow is sampled in situ.

10. The method of claim 7, wherein the far- or mid-infrared signal has a wavelength range from 4000 cm⁻¹ to 10 cm⁻¹.

11. The method of claim 7, wherein a portion of the channel is coated with an anti-contamination coating.

12. The method of claim 7, further comprising treating the mixed-phase flow with an organic solvent prior to being introduced to the channel.

13. The method of claim 7, wherein the mixed-phase flow comprises petroleum.

14. The method of claim 7, wherein the mixed-phase flow comprises petroleum, gas molecules, and water.

15. The method of claim 7, wherein the mixed-phase flow comprises gaseous CO₂, H₂S, N₂ and hydrocarbons.

16. The method of claim 7, wherein the mixed-phase flow comprises wastewater.

17. The method of claim 7, further comprising determining a brine composition and a salinity of the mixed-phase flow based on the transmittance of the mixed-phase flow.

18-32. (canceled)

33. The method of claim 1, wherein the optics assembly is temperature controlled.

34. The method of claim 1, wherein the bypass loop comprises an ultrasonic mixer.

35. The method of claim 7, wherein the channel comprises a temperature-controlled optical cell.
